(19) United States
(12) Patent Application Publication
(10) Pub. No.: US 2003/0060349 A1
(43) Pub. Date: Mar. 27, 2003

(54) Bag-forming machine for making bags with curved bottom walls

(75) Inventors: Arnold Lipes, Montreal (CA); Bruno Wetter, Cote St. Luc (CA)

Correspondence Address: CARTER & SCHNEDLER, P.A., Attn: David M. Carter, P.O. Box 2985, 56 Central Avenue, Suite 101, Asheville, NC, 28802, US

(73) Assignee: Glopak Inc.

(21) Appl. No.: 09/964,945

(22) Filed: Sep. 26, 2001

(51) Int. Cl. B31C 3/00

(52) U.S. Cl. 493/269

(57) ABSTRACT

A machine and method for making plastic bags each having a curved or roundish-like bottom wall and an open top end is described. The machine has a bottom wall forming die having opposed concavely curved seal-forming edges converging to a common apex. The die is heated and reciprocated over a folded film sheet which is oriented such that the die will simultaneously slit heat-fuse opposed film sheets of the folded film sheet when stroked on the film sheet. The die forms opposed concavely curved seals extending from a longitudinal folded side edge of the folded film sheet and converging to an apex at a location spaced on a transverse axis from the longitudinal folded side edge. An evacuation port is located under the folded film sheet in the die-cut area of the folded film sheet and is exposed between slitting and heat-fusing strokes of the die whereby to evacuate the cut-out film portion.

### TECHNICAL FIELD

The present invention relates to a bag-forming machine and method for making plastic bags having a curved or roundish-like bottom wall and an open top end.

### BACKGROUND ART

Bag-forming machines are well known in the art for making plastic bags from a folded film sheet and wherein the bags are packaged for future handling. Bag-forming machines are also known wherein the bags are formed and then filled with a product, closed and the filled bags are conveyed to a packaging location. Such bag-forming machines usually form rectangular shaped bags which are heat-fused along opposed parallel side edges thereof and with the bottom edge being constituted by the folded film sheet. A flap may also be formed adjacent to the open end to handle the bags on wicket pins for filling such bags, and this is also well known in the art.

### SUMMARY OF INVENTION

It is a feature of the present invention to provide a bag-forming machine for making plastic bags having a curved or roundish-like bottom wall and an open top end.

Another feature of the present invention is to provide a method of forming plastic bags having a curved or roundish-like bottom wall and an open top end.

According to the above features, and from a broad aspect of the present invention, there is provided a bag-forming machine for making plastic bags having a curved or roundish-like bottom wall and an open top end. The machine comprises a bottom wall forming die having opposed concavely curved seal-forming edges converging to a common apex. Means is provided to heat the die. A film support assembly is disposed under the die. Means is provided to reciprocate the die over the film support assembly. The folded film sheet is adapted to be displaced over a film support surface of the film support assembly under the die. The folded film sheet is oriented such that the die will simultaneously slit and heat-fuse opposed film sheets of the folded film sheet when stroked on the film sheet to form opposed concavely curved seals extending from a longitudinal folded edge of the folded film sheet and converging to an apex at a location spaced on a transverse axis from the longitudinal folded side edge. Means is provided to evacuate a cut-out film portion of the folded film sheet between the slit and heat-fused strokes of the die. The folded film sheet with the opposed curved seals and cut-out end portion is then fed to bag-forming means.

According to a further broad aspect of the present invention, there is provided a method of forming plastic bags each having a curved or roundish-like bottom wall and an open top end. The method comprises the steps of providing a bottom wall forming die having opposed concavely curved seal-forming edges converging to a common apex. The die is heated by heating means. A folded film sheet is fed on a film support surface under the die. The die is reciprocated over the folded film sheet in synchronism with film feeding means whereby to simultaneously slit and heat-fuse opposed film sheets of the folded film sheet when the die is stroked on the folded film sheet to form opposed concavely curved seals extending from a longitudinal folded side edge of the folded film sheet and converging to an apex at a location spaced on a transverse axis from the longitudinal folded side edge. A cut-out film portion of the folded film sheet is evacuated between the slit and heat-fuse stroke of the die. The folded sheet with the opposed curved seals and cut-out end portion is then fed to bag-forming means.

### BRIEF DESCRIPTION OF DRAWINGS

A preferred embodiment of the present invention will now be described in detail having reference to the accompanying drawings, in which:

FIG. 1 is a top view of the bag-forming machine of the present invention for making curved or roundish-like bottom walls in a folded film sheet;

FIG. 2 is a side view of FIG. 1, partly in schematic;

FIG. 3 is a rear view of FIG. 2, partly in schematic;

FIG. 4 is an exploded view showing the construction of the die and the film support assembly;

FIG. 5 is a schematic top plan view showing a folded film sheet in which curved bottom walls have been formed and further illustrating associated devices to form a bag with such roundish-like bottom wall; and

FIG. 6 is a perspective view showing a bag formed in accordance with the machine and method of the present invention.

### DESCRIPTION OF PREFERRED EMBODIMENTS

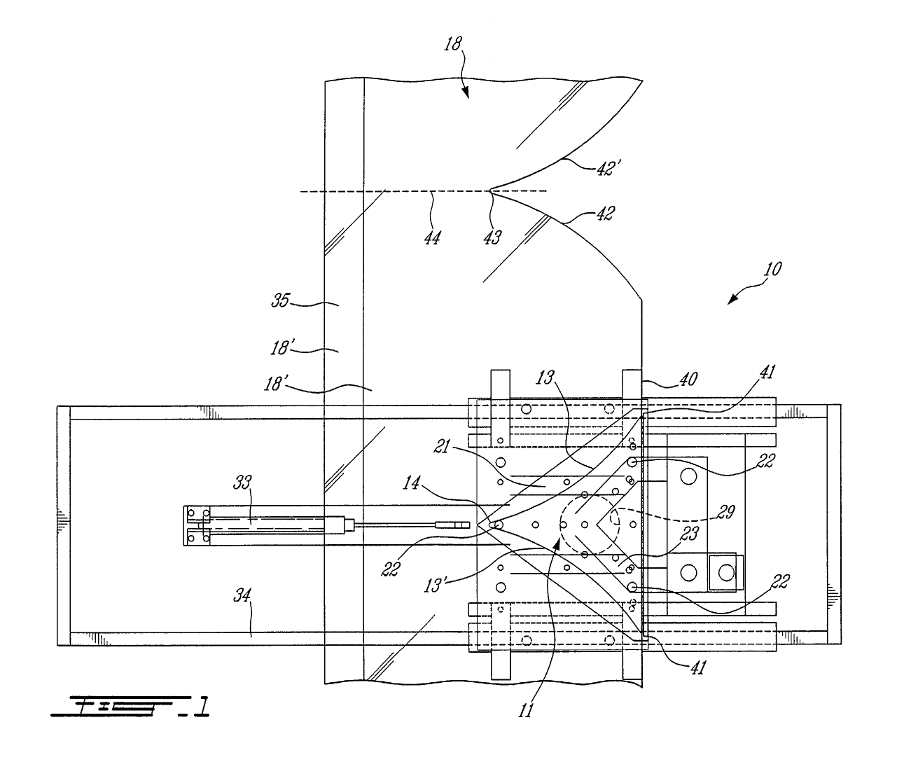

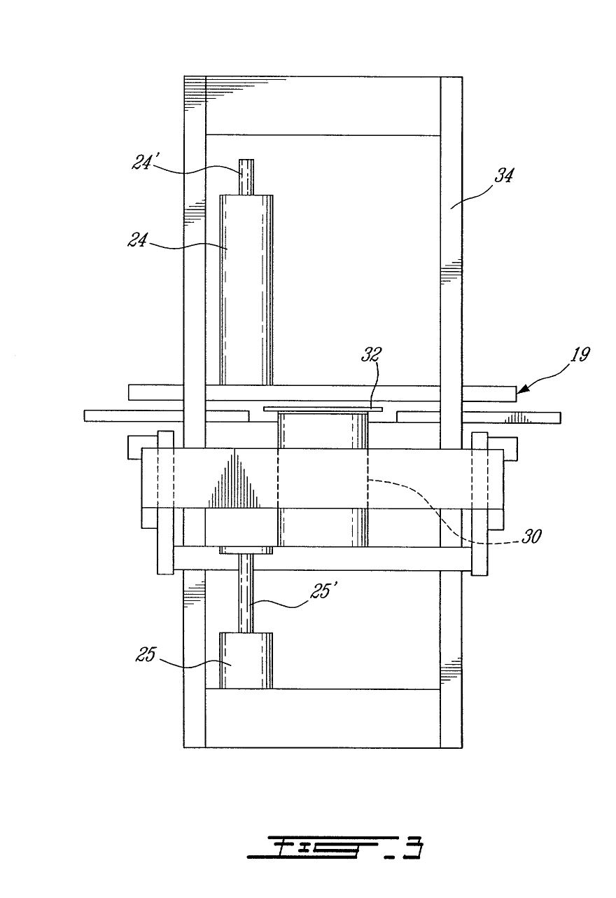

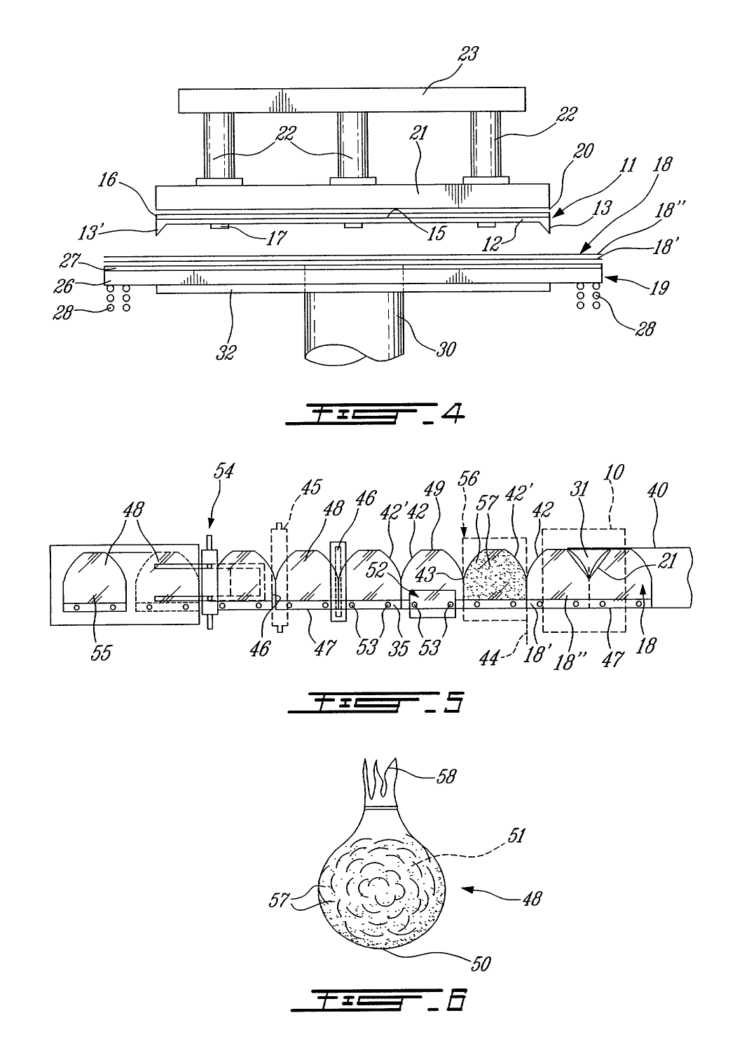

Referring now to the drawings, and more particularly to FIGS. 1 to 4, there is shown generally at 10 the bottom wall forming section of a bag-forming machine, which is more completely and schematically illustrated in FIG. 5. This bottom wall forming section 10 comprises a bottom wall forming die 11, which is better illustrated in FIG. 4. As can be seen, the bottom wall forming die 11 is a heat-conducting die plate 12, having opposed concavely curved seal-forming edges 13 and 13′. These concavely curved seal-forming edges converge to a common apex 14.

The die plate 12 has a flat rear wall 15 over which is disposed a heat-producing resistive wire 16, which is oriented in a serpentine fashion (not shown) whereby to provide sufficient heat to the die plate 12. A heat-sensing thermocouple 17 is conveniently secured to the die plate 12 and generate signals indicative of the temperature of the die plate 12 whereby to control the temperature to provide proper slitting and fusing of a folded film sheet 18 disposed thereunder on a film support assembly 19. A heat-insulating material such as an insulating fabric 20 is disposed over the resistive heating wire 16 and is sandwiched between a connecting plate 21 and the die plate 12 by means of fastening bolts 22. The fastening bolts are secured to a piston-actuated connecting plate 23 which is spaced therefrom by the bolts 22. The insulating material 20 and connecting plate maintain the die plate 12 at a hot temperature and isolated from the piston-actuated plate 23.

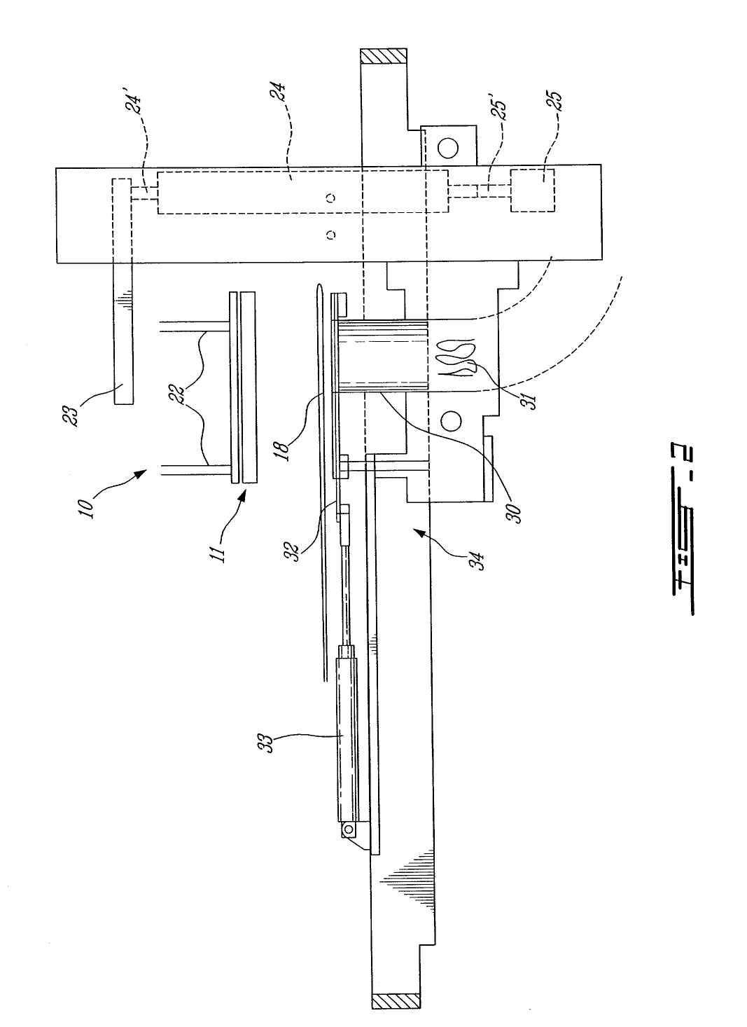

As shown in FIGS. 2 and 3, the piston-actuated plate is connected to two in-line cylinders 24 and 25. These cylinders have their piston rods 24′ and 25′ respectively connected in line with the connecting plate 23. Cylinder 24 is provided for the retracting or standby position of the die assembly 11, while piston 25 provides the reciprocating seal-slit stroke.

With reference now to FIGS. 1, 2 and 4, there will be described the construction and operation of the film support assembly 19. That assembly comprises a film support plate 26 having a Teflon (Registered Trademark) coating 27 thereover or Teflon™ sheet adhered to the upper surface thereof. This film support plate 26 is also resiliently mounted on resilient supports 28.

As can be seen from FIG. 1, a vacuum port 29, herein a round hole, is cut out from the support plate and oriented spaced between the concavely curved seal-forming edges 13 and 13′ of the die. A vacuum conduit 30 is secured to the port and connected to a suction device (not shown) at a far end wherein to evacuate and collect cut-out film portions 31 of the folded film sheet between the slit and heat-fused strokes of the die. The vacuum port 29 also extends to the top surface of the support plate 26 and through the Teflon™ coating, whereby this port is situated under the folded film sheet 18.

A reciprocating plate valve 32 is disposed under the film support plate 26 and connected to a reciprocating piston 33 whereby to obstruct the vacuum port during heat-fusing and slitting of the folded film sheet when the die is stroked thereon and to open the port immediately thereafter to evacuate the cut-out film portion. It is pointed out that the frame assembly 34 may also be mounted on lockable casters whereby the machine can be located in a bag-forming line close other bag-forming devices.

As shown in FIG. 1, the folded film sheet 18 is herein shown as a J-folded film sheet with one of the opposed film sheets, namely sheet 18′, extending to form a flap 35. This film sheet is advanced under the die in an indexing fashion. The plate valve 32 is indexed in synchronism with the pistons which reciprocate the die, and these operate at high speeds.

Referring now to FIG. 5, there is shown a bag-forming machine and method incorporating therein the bottom wall forming section 10. As herein shown, the folded film sheet is oriented with its longitudinally folded edge 40 disposed along the free ends 41 of the opposed concavely curved seal-forming edges 13 and 13′. When the hot die is stroked down onto the folded film sheet 18, it will simultaneously slit and heat-fuse opposed film sheets 18′ and 18″ to form opposed concavely curved seals 42 and 42′ extending from the longitudinal folded side edge 40 of the folded film sheet 18 and converging to an apex 43 at a location spaced on a transverse axis 44 from the longitudinal folded edge 40. Simultaneously as the seals 42 and 42′ are formed, the cut-out film portion 31 is detached and evacuated as above-described.

As shown in FIG. 5, the indexing means may be comprised by feed rolls 45 or feed roll assemblies which contact the folded film sheet and move at a predetermined length during each stroke of the die. The bag-forming means also comprises an indexed vertical slit and seal die 46 disposed at an appropriate location spaced from the bottom wall forming section 10 whereby to form a vertical seal 46 from the apex 43 of the opposed concavely curved sealed edges 42 and 42′ to a non-folded side edge 47 of the folded film sheet 18 and thereby form a bag 48 to be detached from the folded film sheet 18. The formed bag 48 has opposed concavely curved seals 42 and 42′ as herein illustrated, which extend on opposed sides of a remaining central folded edge section 49 of the folded film sheet whereby to form the curved or roundish-like bottom wall 50, as better illustrated in FIG. 6, wherein a produce, herein a lettuce 51, is disposed in this type of a bag.

The bag-forming machine, as illustrated in FIG. 5, is also provided with an indexed wicket pin hole punch 52 to form two spaced-apart holes 53 in the flap 35 between the cut-out end portions 31 of the folded film sheet 18.

The bag-forming machine illustrated in FIG. 5 is further provided with a bag transport turret 54 to position the formed bags 48 on a bag collector 55 in a manner well known in the art whereby to form stacks of formed bags.

As shown in FIG. 6, the bag herein formed is for the specific purpose of bagging lettuce or other produce wherein it is important to aerate the produce when in the bag and, for this purpose, a bag-perforating indexed mechanism 56 is located at a convenient location along the bag-forming line illustrated in FIG. 5. At this station, the folded film sheets are perforated by pins 57 in specific regions of the folded film sheets wherein the bag is to be formed.

Essentially, the method of forming plastic bags 48, having curved or roundish-like bottom walls 50 and an open top end 58, as shown in FIG. 6, comprises the steps of providing a bottom wall forming die 11 having opposed concavely curved seal-forming edges 13 and 13′ converging to a common apex 14. The die is heated by suitable heating means such as the resistive heating wire 16. A folded film sheet 18 is fed on a film support surface, herein a Teflon™ coated surface 27, of a support plate 26 under the die 11. The die is reciprocated on the folded film sheet in synchronism with film feeding means whereby to simultaneously slit and heat-fuse opposed film sheets of the folded film sheet. The die is stroked onto the folded film sheet to form opposed concavely curved seals 42 and 42′ extending from a longitudinal folded side edge 40 of the folded film sheet 18 and converging to an apex 43 at a location spaced on a transverse axis 44 from the longitudinal folded side edge 40. The cut-out film portions 31 are evacuated between the slit and heat-fuse stroke of the die. The folded film sheets with the opposed curved seals and cut-out end portions are fed to a further bag-forming station, as above-described and illustrated in FIG. 5.

It is within the ambit of the present invention to cover any obvious modifications of the preferred embodiment described herein, provided such modifications fall within the scope of the appended claims.

1. A bag-forming machine for making plastic bags having a curved or roundish-like bottom wall and an open top end, said machine comprising a bottom wall forming die having opposed concavely curved seal-forming edges converging to a common apex, means to heat said die, a film support assembly under said die, means to reciprocate said die over said film support assembly, a folded film sheet adapted to be displaced over a film support surface of said film support assembly under said die, said folded film sheet being oriented such that said die will simultaneously slit and heat-fuse opposed film sheets of said folded film sheet when stroked on said folded film sheet to form opposed concavely curved seals extending from a longitudinal folded side edge of said folded film sheet and converging to an apex at a location spaced on a transverse axis from said longitudinal folded side edge, means to evacuate a cut-out film portion of said folded film sheet between said slit and heat-fuse strokes of said die, said folded film sheet with said opposed curved seals and cut-out end portion being fed to bag-forming means.

2. A bag-forming machine as claimed in claim 1 wherein said bottom wall forming die is comprised of a heat-conducting die plate with said concavely curved seal-forming edges formed integral therewith, said die plate having a rear wall on which is disposed heating elements constituting said means to heat said die, heat-sensing means associated with said die plate, a support plate secured to said die plate, a heat insulating material over said heating elements and between said die plate and said support plate, a piston-actuated connecting plate secured to said support plate and spaced therefrom.

3. A bag-forming machine as claimed in claim 2 wherein said die is connected to two in-line mounted cylinders, one said cylinder being a die-retracting cylinder, and the other of said cylinder being a die-reciprocating cylinder, said cylinders having in-line piston rods secured to said connecting plate.

4. A bag-forming machine as claimed in claim 1 wherein said film support assembly comprises a film support plate defining said support surface, a Teflon™ material coated on said support surface, said film support plate being resiliently mounted, a vacuum port in said film support plate and oriented between said concavely curved seal-forming edges of said die, a vacuum conduit secured to said port and constituting said means to evacuate, and a reciprocating plate valve under said film support plate to obstruct said vacuum port during heat-fusing and slitting of said folded film sheet when said die is stroked thereon.

5. A bag-forming machine as claimed in claim 4 wherein said plate valve is a piston-operated plate valve synchronized with said means to reciprocate said die, said plate valve when retracted uncovering said port to suck out said cut-out film portion.

6. A bag-forming machine as claimed in claim 1 wherein said bag-forming means comprise indexing means to displace said folded film sheet over said film support surface of said film support assembly, and an indexed vertical slit and seal die to form a seal from said apex of said opposed concavely curved seals to a non-folded side edge of said folded film sheet and cause a formed bag to be detached from said folded film sheet, said bag having opposed concavely curved seals extending on opposed sides of a remaining central folded edge section whereby to form said curved or roundish-like bottom wall.

7. A bag-forming machine as claimed in claim 6 wherein said folded film sheet is a J-folded film sheet defining a flap at said open top end, said bag forming means further comprising an indexed wicket pin hole punch to form two spaced-apart holes in said flap between said cut-out end portions of said folded film sheet.

8. A bag-forming machine as claimed in claim 7 wherein said bag-forming means further comprises bag transport means to position a formed bag on a bag collector to form stacks of formed bags.

9. A bag-forming machine as claimed in claim 6 wherein said bag-forming means further comprises an indexed bag perforator to perforate said folded film sheets in a predetermined area thereof.

10. A method of forming plastic bags each having a curved or roundish-like bottom wall and an open top end, said method comprising the steps of:
i) providing a bottom wall forming die having opposed concavely curved seal-forming edges converging to a common apex;
ii) heating said die, by heating means;
iii) feeding a folded film sheet on a film support surface under said die;
iv) reciprocating said die on said folded film sheet in synchronism with film-feeding means whereby to simultaneously slit and heat-fuse opposed film sheets of said folded film sheet when said die is stroked on said folded film sheet to form opposed concavely curved seals extending from a longitudinal folded side edge of said folded film sheet and converging to an apex at a location on a transverse axis from said longitudinal folded side edge;
v) evacuating a cut-out film portion of said folded film sheet between said slit and heat-fuse stroke of said die; and
vi) feeding said folded film sheet with said opposed curved seals and cut-out end portion to bag-forming means.
